(19) United States
(12) Patent Application Publication
(10) Pub. No.: US 2014/0249876 A1
(43) Pub. Date: Sep. 4, 2014

(54) Adaptive Stochastic Controller for Energy Efficiency and Smart Buildings

(71) Applicants: The Trustees of Columbia University in the City of New York, New York, NY (US); Rudin Management Co., Inc., New York, NY (US); Consolidated Edison Energy Company of New York, New York, NY (US)

(72) Inventors: Leon L. Wu, New York, NY (US); Albert Boulanger, New York, NY (US); Roger N. Anderson, New York, NY (US); Eugene M. Boniberger, West Islip, NY (US); Arthur A. Kressner, New York, NY (US); John J. Gilbert, New Rochelle, NY (US)

(21) Appl. No.: 14/203,151

(22) Filed: Mar. 10, 2014

Related U.S. Application Data
(63) Continuation of application No. PCT/US2012/056321, filed on Sep. 20, 2012.
(60) Provisional application No. 61/536,930, filed on Sep. 20, 2011.
(60) Provisional application No. 61/638,965, filed on Apr. 26, 2012.
(60) Provisional application No. 61/672,141, filed on Jul. 16, 2012.

(51) Int. Cl. G06Q 10/06

(52) U.S. Cl. CPC G06Q 10/0631
USPC 705/7.12

(57) ABSTRACT

Techniques for managing one or more buildings, including collecting historical building data, real-time building data, historical exogenous data, and real-time exogenous data and receiving the collected data at an adaptive stochastic controller. The adaptive stochastic controller can generate at least one predicted condition with a predictive model. The adaptive stochastic controller can generate one or more executable recommendations based on at least the predicted conditions and one or more performance measurements corresponding to the executable recommendations.

### CROSS-REFERENCE TO RELATED APPLICATIONS

This application is a U.S. continuation application of PCT/US12/056,321 filed Sep. 20, 2012, which is related to U.S. Provisional Application Ser. No. 61/536,930, filed on Sep. 20, 2011, U.S. Provisional Application Ser. No. 61/638,965, filed on Apr. 26, 2012, and U.S. Provisional Application Ser. No. 61/672,141, filed on Jul. 17, 2012, which are each incorporated herein by reference in their entirety and from which priority is claimed.

### BACKGROUND

The disclosed subject matter relates to techniques for improving the efficiency and reliability of the operation of buildings and/or collections of buildings held by a property owner.

Building energy use can be measured by total electricity, steam and natural gas consumption over a period of time, for example in kilowatt-hours (kWh) per month. The kilowatt-hour can serve as a billing unit for energy delivered to consumers by electric utilities. The energy demand of a building can be measured by the rate of energy consumption by the building. Because energy use fluctuates during the week due to tenant activities and building operation schedule, energy demand can be a more fine-grained measure of building energy use than the aggregate kilowatt-hours consumed during the whole period. The lease obligation of a building owner to tenants can be focused on comfort, with bounding limits often set for temperature, humidity, and air quality, while also increasingly heeding environmental mandates and incentives.

Commercial and residential buildings can be designed for tenant comfort, energy efficiency and system reliability in mind with the use of energy-efficient materials and Building Management Systems (BMS). BMS can integrate a number of components to assist building operators with maintenance and operation. For example, a building can include lighting systems, air conditioning, heating systems, elevator management systems, power systems, fire system, and security systems and the like. In certain circumstances, BMSs can be used to retrieve building energy-related data, such as data reading from sub-meters and sensors. Such systems can be operated in such a manner as to reduce costs of operation while maintaining quality of comfort for tenants, and in some circumstances to comply with mandates or incentives from local, state, and federal governmental regulation. However, building management systems do not always guarantee tenant comfort and reliable building operation if they do not measure space temperatures sufficiently. New buildings can consume energy at levels that exceed specifications and experience system failures after being put into use.

Accordingly there is a need for improved techniques for improving the comfort, energy efficiency and reliability of building operations and management.

### SUMMARY

The disclosed subject matter relates to techniques for managing one or more buildings.

In one aspect of the disclosed subject matter, a method for managing one or more buildings includes collecting historical building data, real-time building data, historical exogenous data, and real-time exogenous data. The collected data can be received at an adaptive stochastic controller, and the adaptive stochastic controller can generate a predicted condition, such as predicted space temperature, supply air temperature, chilled water temperature, electric load, steam consumption or fuel consumption, required to sustain tenant comfort using a predictive model. The adaptive stochastic controller can further generate one or more executable recommendations based on at least the predicted condition and one or more performance measurements such as space temperatures on one or more floors corresponding to the executable recommendations.

In one embodiment, the historical and real-time building data, and historical, real-time, and forecast exogenous weather data, can be collected from a weather service such as the United States National Weather Service (NWS) and input into a machine learning model as covariates. Additionally or alternatively, the historical and real-time building data, and the historical, real-time and forecast exogenous weather data, can be collected by querying one or more databases, or web services such as those maintained by Weather Underground and WeatherBug. Additionally, or alternatively, the historical and real-time building data, and the historical and real-time exogenous data, can be collected by receiving the data over a network. In addition, weather sensors placed in or on the building can be used—buildings often have temperature and dew point sensors already existing than can be harnessed and their history stored in the building's BMS. The historical and real-time building data can include electric data, gas and steam data, space temperature information data, air flow rate data, tenant occupancy data, supply air temperature information data, and return air temperature information data, chilled water temperatures and carbon dioxide data. The historical and real-time exogenous data can include historical weather data, forecast weather data, and power grid data. As used herein, the term “temperature information” and “temperature data” can include a temperature value, for example in degrees Celsius of Fahrenheit, as well as humidity and/or dew point values.

In one embodiment, the method can further include generating the one or more performance measurements based on at least data from monitoring one or more building conditions. Additionally or alternatively, the method can include displaying on a user interface that trends one or more building conditions such as space temperature information, compared with the predicted electric, steam and/or natural gas load, and/or one or more executable recommendations such as lowering the speed of supply air electric fans using VFDs when the machine learning system within the Adaptive Stochastic Controller detects tenant occupancy dropping toward the end of the workday, for example using a proxy for occupancy such as the drop in space temperature attributable to body heat and the use of personal equipment such as computers, or data from turnstiles or the like. The method can further comprise identifying trends in the one or more building conditions and generating a predicted condition of overall performance for each building and condition. The identified trends and the predicted conditions can be displayed, whereby an operator can be alerted when an anomaly between the predicted conditions and the actual building metrics arises.

In one embodiment, the one or more building conditions can include perimeter and interior space temperatures at each measurement location of each floor in one or more buildings. Generating the one or more executable recommendations can include generating a recommended start-up time or ramp-down time for a HVAC system based on at least the trends in the one or more building conditions and the exogenous weather forecast. Additionally or alternatively, generating the one or more executable recommendations can include generating a recommended start-up or ramp-down time for a HVAC system based on the predicted conditions, including for example, steam load, and the performance measurements.

In another aspect of the disclosed subject matter, a system for managing one or more buildings includes a data collector to collect historical building data, real-time building data, historical exogenous data, and real-time exogenous data. An adaptive stochastic controller can be operatively coupled to the data collector and adapted to receive collected data therefrom. The adaptive stochastic controller can include a predictive model configured to generate at least one predicted condition, such as predicted space temperature, supply air temperature, chilled water temperature, electric load, steam consumption or fuel consumption, outside temperature information, used to regulate chilled water in the HVAC chillers. The adaptive stochastic controller can further include a decision algorithm configured to generate one or more executable recommendations based on at least the predicted conditions and one or more performance measurements corresponding to the executable recommendations. The decision algorithm can be a rule based system or Approximate Dynamic Programming (ADP) based engine. Additionally or alternatively, the decision algorithm can be based on an optimization model or learned model that can map a state to a decision/action, such as a technique based on fuzzy logic control, a neural network, model predictive control, stochastic programming, linear programming, integer programming, mixed integer nonlinear programming, machine learning classifier, logistic regression, or a combination thereof.

In one embodiment, the data collector can be operatively coupled to a building management system. The historical building data and the real-time building data can include data from one or more of electric meters, gas and steam sub-meters, space temperature information sensors, supply air temperature information sensors, air flow rate sensors, return air temperature information sensors, or carbon dioxide sensors. Additionally or alternatively, the data collector can be operatively coupled to one or more databases included the historical building data, real-time building data, historical exogenous data, and real-time exogenous data. Additionally or alternatively, the data collector can be operatively coupled to a network and configured to receive the data via the network.

In one embodiment, the system can further include a user interface configured to display trends in one or more building conditions, the predicted conditions, and the one or more executable recommendations. The predictive model can be further configured to identify trends in the one or more building conditions and generate a predicted condition for each building condition. The display can be further configured to display the identified trends and the predicted conditions, whereby an operator can be alerted when an anomaly between the predicted condition and the building conditions arises.

In one embodiment, the one or more building conditions can include space temperature information at each measurement location of each floor in the buildings. The decision algorithm can be further configured to generate a recommended start-up time or ramp-down time for a HVAC system based on at least the trends in the building conditions, the predicted conditions, and the performance measurements.

### BRIEF DESCRIPTION OF THE DRAWINGS

FIG. 1 is a block diagram of a system for control and workflow management of a cyber-physical system.

FIG. 2 is a block diagram of a system for control of a cyber-physical system in accordance with the disclosed subject matter.

FIG. 3 is a block diagram of a system for managing one or more buildings in accordance with an embodiment of the disclosed subject matter.

FIG. 4 depicts an exemplary display and a user interface in accordance with an embodiment of the disclosed subject matter.

FIG. 5 is a flow diagram of a method for management of one or more buildings in accordance with an embodiment of the disclosed subject matter.

FIG. 6 depicts another user interface in accordance with an embodiment of the disclosed subject matter.

FIG. 7 depicts another user interface in accordance with an embodiment of the disclosed subject matter.

FIG. 8 depicts another user interface in accordance with an embodiment of the disclosed subject matter.

FIG. 9 depicts another user interface in accordance with an embodiment of the disclosed subject matter.

FIG. 10 depicts another user interface in accordance with an embodiment of the disclosed subject matter.

FIG. 11 depicts another user interface in accordance with an embodiment of the disclosed subject matter.

FIG. 12 depicts the results of an excremental example of an embodiment of the disclosed subject matter.

Throughout the drawings, the same reference numerals and characters, unless otherwise stated or indicated by context, are used to denote like features, elements, components or portions of the illustrated embodiments. Moreover, while the disclosed subject matter will now be described in detail with reference to the Figs., it is done so in connection with the illustrative embodiments.

### DESCRIPTION

Commercial office buildings or multi-unit residential buildings can experience energy consumption that exceeds specifications and system failures. Disclosed herein are techniques for improving comfort, energy efficiency and reliability of building operations without the need for large additional capital investments. For purpose of illustration and not limitation, the techniques disclosed herein can use a machine learning predictive model to generate energy demand forecasts and automated analysis that can guide optimization of building operations to improve tenant comfort while improving energy efficiency. An automated online evaluation system can monitor efficiency at multiple stages in the system workflow and provide operators with continuous feedback, for example, to evaluate operator actions if the operator devices from a recommendation generated by the techniques disclosed herein. A user interface can be provided to display a representation of the building conditions, predicted conditions, and executable recommendations.

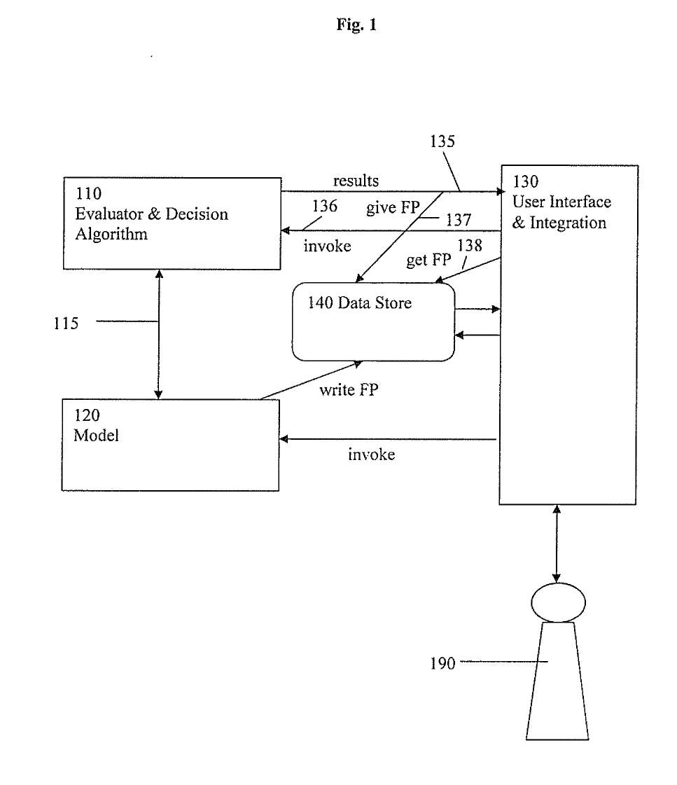

Controlling and managing one or more buildings, like other cyber-physical systems, can be a multistage, time-variable, stochastic optimization endeavor. Adaptive Stochastic Control (ASC) using, for example, approximate dynamic programming (ADP) can offer the capability of achieving autonomous control using computational learning systems to manage the building systems. Additionally, as used herein, the term “Adaptive Stochastic Control” can include a number of decision techniques, such as methods based on a neural network, fuzzy logic control, model predictive control, stochastic programming, linear programming, integer programming, mixed integer nonlinear programming, machine learning classifier, logistic regression, or the like, and/or any combination thereof. For purpose of illustration and not limitation, and with reference to FIG. 1, an exemplary system for controlling and managing workflow in a cyber-physical system can include a user interface 130 integrated with and operatively coupled to a number of modules. For example, the user interface 130 can be coupled to an evaluator and decision algorithm 110, a model 120, and a data store 140.

For example, the user interface 130 can be configured to communicate with the evaluator and decision algorithm 110 so as to receive results 135 and send data 136 which can be obtained from the data store 140. In like manner, the user interface 130 can be configured to communicate with the data store 140 to send and receive data, e.g. failure probability prediction (FP) data 138 and 137. Additionally, the user interface 130 can be configured to invoke a model 120. The model 120 can be operatively connected, for example via a wired, wireless, or flat file communication protocol 115, with the evaluator and decision algorithm 110. A user 190 can operate and interact with the user interface 130 to facilitate control and management of the cyber-physical system. As described in more detail herein, the modules 110 and 120 can be selected based on a desired task.

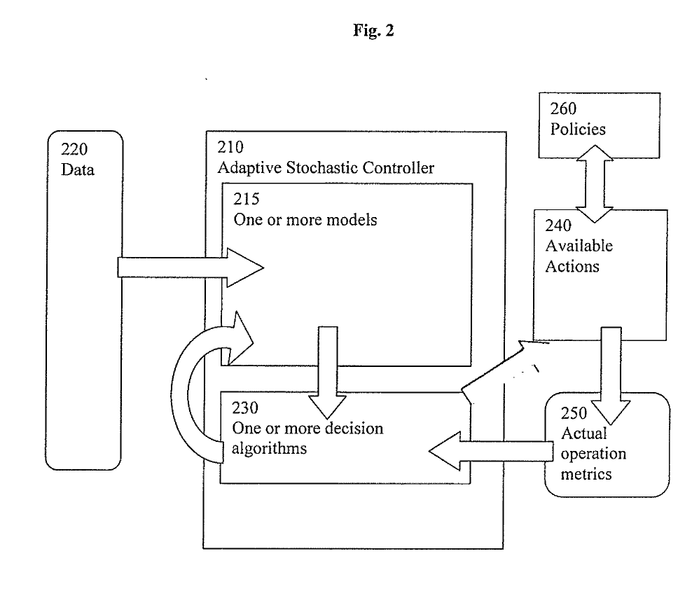

For purposes of illustration and not limitation, a system for managing a cyber physical system can have a framework such as the one depicted in FIG. 2. Generally, data representative of a cyber-physical system 220 can be collected. The data 220 can be processed and formatted and can be stored, for example, in one or more databases. For example, the data 220 can be collected with a data collector, which can include a computer programmed to interface with and receive the data internally from the cyber-physical system or from a remote system. That is, the cyber-physical system or a remote system can transmit (330) the data to the data collector, which can then store the data 220 in a database.

An adaptive stochastic controller 210 can be operatively coupled to the data collector and adapted to receive collected data 220 from the data collector. As used herein, the term “adaptive stochastic controller” can include a controller that can simulate multiple potential future outcomes in order to quantify uncertainty and adapt desired actions and policies. For example, as described herein, an adaptive stochastic controller can use approximate dynamic programming to predict emerging problems and recommend operational actions to enhance performance, and can include verification, e.g., via feedback, of one or more predictive models. Further, as described herein, an adaptive stochastic controller, e.g., via feedback and being online, can auto-correct and employ machine learning to modify actions taken on the system over time as external forces change. That is, for example, an adaptive stochastic controller can measure cause-and-effect and adjust learning accordingly. The adaptive stochastic controller 210 can include, for example, an innervated stochastic controller such as disclosed in U.S. Pat. No. 7,395,252. Additionally or alternatively, the adaptive stochastic controller 210 can include a machine learning and/or statistical modeling element. For example, the adaptive stochastic controller 210 can include a machine learning element employing martingale boosting such as disclosed in U.S. Pat. No. 8,036,996, which is hereby incorporated by reference in its entirety. Additionally or alternatively, the adaptive stochastic controller 210 can include an element utilizing a technique based on a rule based system, neural network, fuzzy logic control, model predictive control, stochastic programming, linear programming, integer programming, mixed integer nonlinear programming, machine learning classifier, logistic regression, or a combination thereof.

One or more of the recommended actions 240 can be generated. For example, element 230 can generate a set of proposed actions 240 which can then be executed manually. Alternatively, such proposed actions can be executed in an autonomous manner. After an action 240 has been executed, metrics 250 of the cyber-physical system can be collected. The metrics 250 can include, for example, information regarding the state of the cyber-physical system, the components of the cyber-physical system, as well as external information. Moreover, the metrics 250 can include predictions as well as data generated by a model. The actual operation metrics 250 can include data analogous to data 220. That is, data 220 can be a subset of the actual operation metrics 250. Additionally or alternatively, data 220 can represent a measurement that can be altered by a change in operation under the control of the adaptive stochastic controller 210.

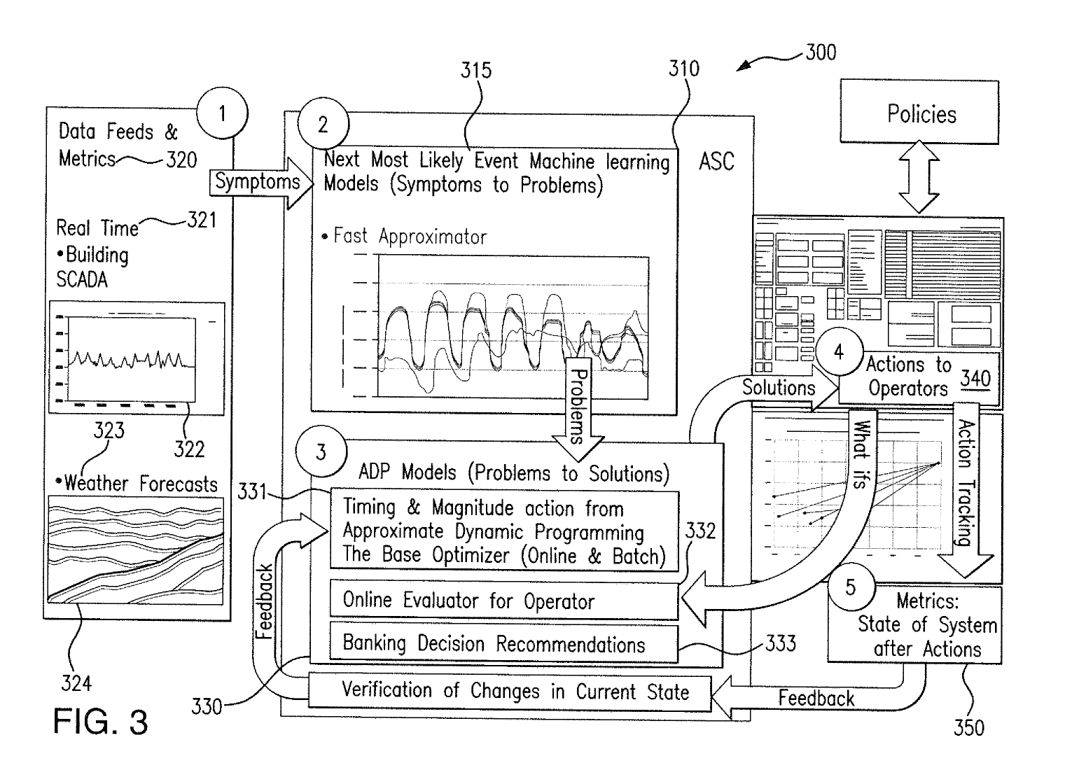

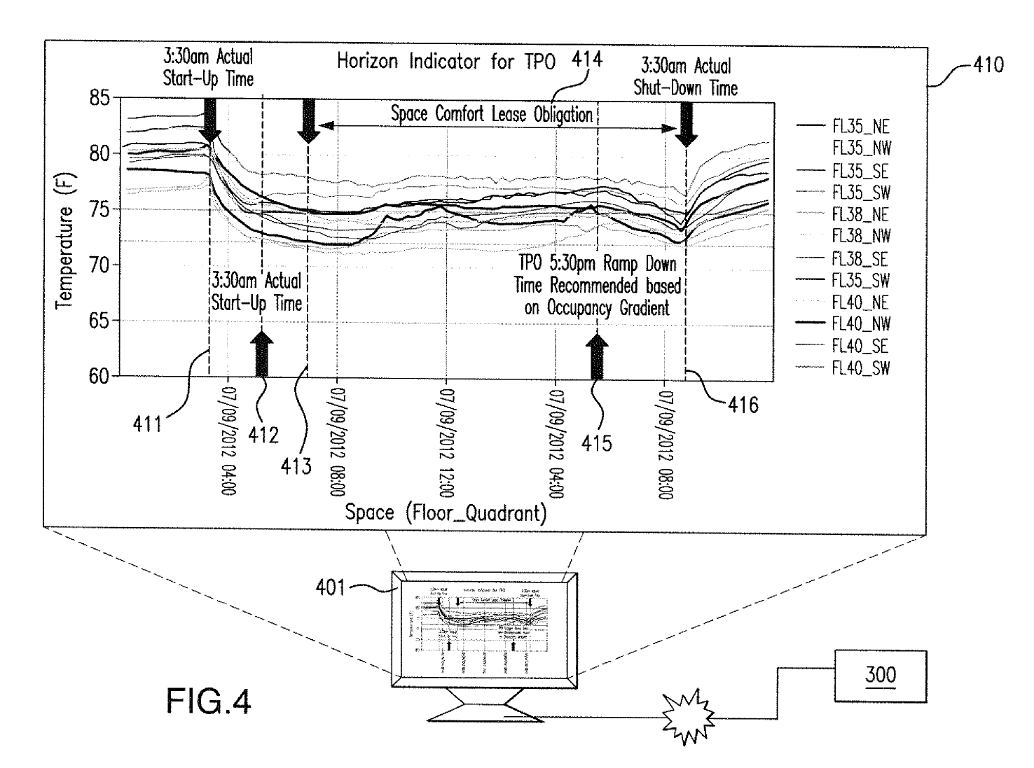

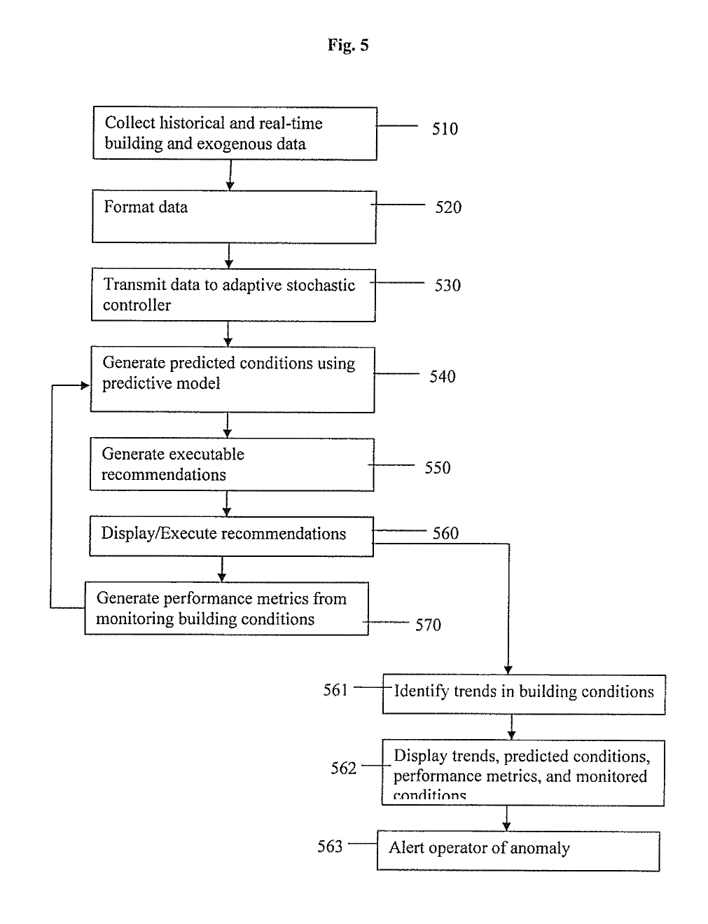

Particular embodiments of the system and method are described below, with reference to FIG. 3, FIG. 4, and FIG. 5, for purpose of illustration and not limitation. For purpose of clarity, the method and system are described concurrently and in Conjunction with each other. The system and methods described below can be referred to as the “Total Property Optimization” system.

In an exemplary embodiment, techniques for managing one or more buildings can include collecting (510) historical building data 322, real-time building data 321, historical exogenous data 323, and real-time exogenous data 324 with a data collector 320. The historical and real-time building data can include, for example, all Building Management System data (BMS) data and other building information, including without limitation data from lighting systems, air conditioning, heating systems, elevator management systems, power systems, fire systems, security systems and the like. The historical and real-time exogenous data can include, for example, weather data (historical and forecast), power grid data, energy data such as steam and natural gas usage, tenant-by-tenant occupancy over time, and lease requirements such as comfortable space temperature information during working hours and what the working hours are. Weather data can include, for example, temperature information (including humidity data) for both the interior and exterior of buildings, forecasts of day-ahead temperature and humidity changes, wind and storm magnitudes and trajectories.

The historical and real-time building data can also include building energy use data, which can be provided, for example, from Building Management System (BMS), Elevator Information Management System (EIMS) and Energy Management System (EMS). BMS can collect data from, among other things, electric, gas and steam sub-meters and space temperature information, HVAC equipment measurements such as air flow rates, supply air temperature information, return air temperature information, and various environmental sensors such as carbon dioxide content of the return air. The historical and real-time data can also include power grid data, including for example, electrical demand and consumption, peak historical and future predicted loads, electric power quality, including frequency and voltage, steam generation and consumption, fossil fuel (including without limitation heating oil and natural gas) usage and pricing, and power failure warnings. Such data can be transmitted electronically from a utility company, for example, via a web portal or email, or sensed by low voltage power quality measurement systems, smart meters or electric power consumption meters, or analogous steam and fuel consumption meters, that provide external signals inside the building or buildings.

The collected data 320 can be formatted (520), for example with a preprocessor. For example, weather and power grid data can be combined with building energy usage, occupancy variations by floor, space temperature information, supply and return air temperature information and chilled water return temperatures in a data aggregator. A data preprocess can clean and format the data for normalization. In an exemplary embodiment, the data can be normalized between a value of 0 and 1 for equal weighting. Additionally, data can be converted into consistent units of measurement. In certain embodiments, the preprocessor can also handle missing data by imputing values and correct for outliers and/or interpolate/extrapolate data in time or space.

The collected data 320 can be received (i.e., transmitted to) (530) at an adaptive stochastic controller 310, and the adaptive stochastic controller 310 can generate (540) a predicted condition with a predictive model 315. The predictive model 315 can be, for example, a predictive machine learning model. Additionally or alternatively, the predictive model 315 can be a model based on a first-principles physics model, neural network, statistical auto-regression, machine learning regression, statistical regression, or a combination thereof. The predicted condition can be, for example, a predicted condition or forecast over a predetermined period, such as a day, a week, a month, or the like. The predicted condition can be, for example, predicted space temperature, supply air temperature, chilled water temperature, electric load, steam consumption or fuel consumption. Additionally or alternative, the predicted condition, with respect to conditions involving energy usage, can be given in units of instantaneous energy demand rather than, e.g., average kilowatt-hours, to allow for highly granular measurements. Certain machine learning techniques can be employed to generate the predicted condition, such as neural networks, statistical auto-regression techniques such as Seasonal Auto Regressive Integrated Moving Average (SARIMA) and Bayesian Additive Regression Tress (BART), and Support Vector Machines (SVMs). Martingale boosting such as disclosed in U.S. Pat. No. 8,036,996 or Adaptive Stochastic Control using Approximate Dynamic Programming such as disclosed in U.S. Pat. No. 7,395,252 can be used in connection with the predictive model.

The adaptive stochastic controller 310 can further generate (550) one or more executable recommendations 340 with a decision algorithm 330 based on at least the predicted conditions and one or more performance measurements 350 corresponding to the executable recommendations 340. The decision algorithm 330 can be, for example, a rule based system, an ADP, linear programming, neural network, fuzzy logic control, model predictive control, stochastic programming, linear programming, integer programming, mixed integer nonlinear programming, machine learning classifier, logistic regression, or a combination thereof. In one embodiment, for example, the decision algorithm 330 can receive the collected data 320 and the output of the predictive model 315. Business knowledge support rules, constraints, priorities, mutual exclusions, preconditions, and other functions can be applied to the data 320 to derive executable recommendations 340 for each building or collections of buildings. The executable recommendations 340 can be, for example, inspection orders, repair orders, work schedules, HVAC Start-Up and Ramp-Down times (e.g., as described in more detail below with reference to FIG. 4), and preventative maintenance actions such as those embodied in U.S. Pat. No. 7,945,524, which is hereby incorporated by reference in its entirety. In one embodiment, the decision algorithm 330 can include a business process management component (BPM) and a business rules management component (BRM), which can interact with each other while responding to events or executing business judgments defined by business rules or rules induced by machine learning systems. Approximate Dynamic Programming algorithms like those embodied in U.S. Pat. No. 7,395,252, which is incorporated by reference herein, can be utilized in connection with the generation of executable recommendations 340.

In one embodiment, the one or more performance measurements 350 can be generated (570) with an automated online evaluator 332 based on at least data from monitoring one or more building conditions. The automated online evaluator 332 can be configured to monitor one or more building's internal and external conditions, operator control actions, and evaluate the results of those operator actions to provide feedback to the adaptive stochastic controller 310. Far example, the automated online evaluator 332 can be used to evaluate operator actions that deviate from what the ASC recommends to the operator. In certain embodiments, certain components, such as for example the “Horizon Indicator” as described in more detail below, can detect anomalies in performance of equipment or in external conditions, and automatically display or transmit feedback in the form of customized dashboards for a building operator.

The one or more performance measurements 350 can include, for example, cost benefit analyses evaluating energy efficiency improvements against lease contracts with tenants for the provision of comfort of the building occupants. In certain embodiments, the performance measurements 350 can include a comparison of energy usage for specific tenants so as to enable coordination with their respective secondary heating, cooling, and/or lighting systems to enable additional energy efficiencies. Moreover, the performance measurements 350 can include a scoring and/or relative accuracy rating of forward looking forecasts generated from the predictive model 315.

Additionally or alternatively, the techniques disclosed herein can include displaying (560) on a user interface 410 of a display device 401 trends in the one or more building conditions, the predicted conditions, and/or the one or more executable recommendations 340. Trends in the one or more building conditions can be identified (561) and a predicted condition for each building condition can be generated. The identified trends and the predicted conditions can be displayed (562) so as to alert (563) an operator can when an anomaly between the predicted conditions and the actual building condition arises. For purpose of illustration and not limitation, the building conditions can be, for example, motor load in connection with a HVAC system. The motor load can be predicted and compared to actual motor load conditions, and thus a potential problem can be identified if there is an anomaly. This can enable preventative maintenance of the HVAC system to take place.

In an exemplary embodiment, and with reference to FIG. 4, techniques for building management can include the use of a real time “Horizon Indicator.” For purposes of illustration and not limitation, the Horizon Indicator 410 can be analogized to the display in an airplane cockpit central to the pilots understanding of the condition of the plane relative to the horizon—in the building embodiment, it can be used to detect performance anomalies and show whether one or more buildings are performing as expected.

For example, real-time trending of space temperatures can be reported by the BMS system into the total property optimization system 300 by floor and quadrant (or in certain embodiments, by a finer or courser spatial division). The Horizon Indicator 410, in connection with other components of the total property optimization system 300, such as the predictive model 315 and the automated online evaluator 332, can identify temperature trends and subsequent inspection and repair results and feed them into ASC 310. These trends can be interpreted by components of the ASC 310 as the thermal signature of specific spaces in the building.

The Horizon Indicator 410 can be configured to analyze occupancy patterns, tenant behavior, and characteristics of the space, and can identify tenant behaviors that correspond to changes in temperatures in different spaces (e.g., total tenant space, floors, conference rooms, cubicles, and traditional offices). As the historical record from the Horizon Indicator grows, it can become an empirical database of the effects of architecture, operations, and tenant behavior on the thermodynamic behavior of building spaces. Moreover, the Horizon Indicator can become a record for characterizing normality for the purpose of anomaly detection as described herein.

In one embodiment, the Horizon Indicator can be presented to an operator in the form of a dashboard including the executable recommendations. When the space temperature does not follow its predicted signature, an anomaly can be identified and building operators can be alerted to potential operational problems. Because the Horizon Indicator monitors space temperatures in real time, a recommended change in tenant comfort can be observed within minutes after it is made. Compensatory changes recommended by the TPO system 300 to the building operator can correct a problem before a tenant notices any discomfort. Additionally, the Horizon Indicator and accompanying display can enable an operator to better understand lag times associated with tenant behavior such as occupancy, operational decisions, and temperature changes in spaces throughout buildings.

In accordance with this exemplary embodiment, the automated online evaluator 332 can monitor a building's internal and external conditions, which can include, for example, space temperature by quadrant (or in certain embodiments, by a finer or courser spatial division) on every floor, electric load, peak load predicted time and magnitude, fluctuating electricity pricing, building work and maintenance schedules, and the like. Additionally, the automated online evaluator can monitor the executable recommendations 340 and score the results of those actions, for example where an operator's action deviates from the executable recommendations 340, the actions including for example lighting levels, air conditioning or heat controls, load shedding such as safely shutting off elevators to optimize electrical usage during emergencies, heating ventilation and air conditions (HVAC) system optimization, and tenant comfort level maintenance regardless of occupancy levels on each floor.

For purposes of example, and not limitation, FIG. 4 depicts a user interface 410 on a display device 401 including a display of trends in space temperature per quadrant (or in certain embodiments, by a finer or courser spatial division) of each building floor. The user interface 410 also displays executable recommendations, including recommended start-up time 412 for the HVAC system and recommended ramp down time 415 for the HVAC system. Executable recommendations 412 and 415 can be generated with the ASC 310 and automatic online evaluator 332 based on, among other things, the space comfort lease obligations 414 and trends in the monitored building conditions. Actual start-up time 411 and actual shut-down and ramp-down time 416 are also displayed on the user interface 410.

With reference to FIG. 4, for example, the Horizon Indicator shows that the HVAC system started up at 3:30 AM and resulted in cooling of the spaces to temperatures that reaches optical comfort values at approximately 5 AM. Thus, the start up time can be interpreted as too early, for example, where the floors are desired to reach those temperatures only at the 7 AM lease requirement. However, though temperatures remained largely horizontal on certain floors, the southwest quadrant of Floor 35 can be deemed to have been too warm throughout the day.

Additionally, in accordance with this exemplary embodiment, Support Vector Machine Regression (SVR) can be used to build models, including but not limited to Individual Day Models (IDMs) and Individual Hour Models (IHMs), based on learning the historical behavior of the thermodynamics of the building using past history for a particular unit of time, including an hour of the week or an hour of the day. A nonlinear kernel function can allow the fitting of a maximum-margin hyperplane in a transformed feature space. A Gaussian radial basis function can serve as the support vector machine kernel function. The support vector machine can be trained on a training set of data to build a predictive model (e.g., a function that can be used for predicting future values). Additionally, time delay coordinates, derivative coordinates, or other phase space reconstruction methods can be employed in order to create the feature vectors of the support vector machine used for SVR.

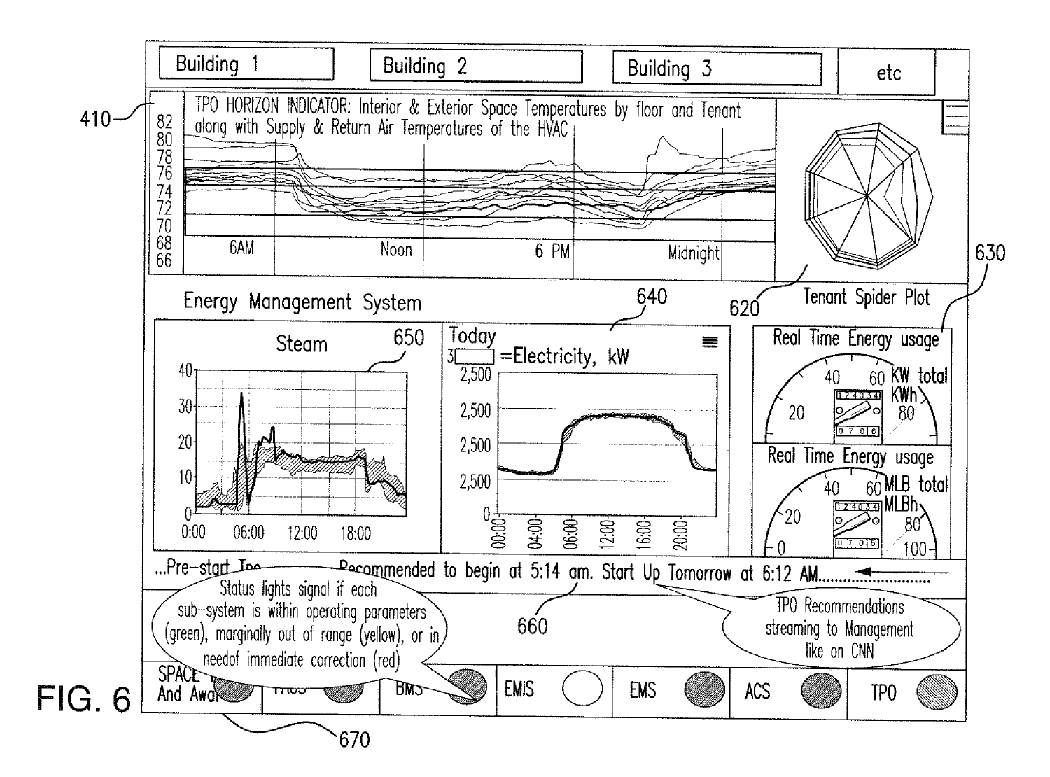

FIG. 6 depicts an exemplary user interface, or “dashboard” in accordance with the disclosed subject matter. The dashboard can include a display of the Horizon Indicator 410, a spider plot 620 of metrics related to tenant occupancy, and a representation of real time energy usage and real time steam usage 630. Additionally, the dashboard can include a display of historical steam usage 650 and electricity usage 640. Executable recommendations 340 can be displayed, for example, in a streaming fashion with a ticker 660. Additionally, the dashboard can include a color coded indication 670 of the status of each subsystem within a building. For example, a green icon can indicate that a particular system is operating within suitable operating parameters, while a red icon can indicate that a system is in need of immediate correction.

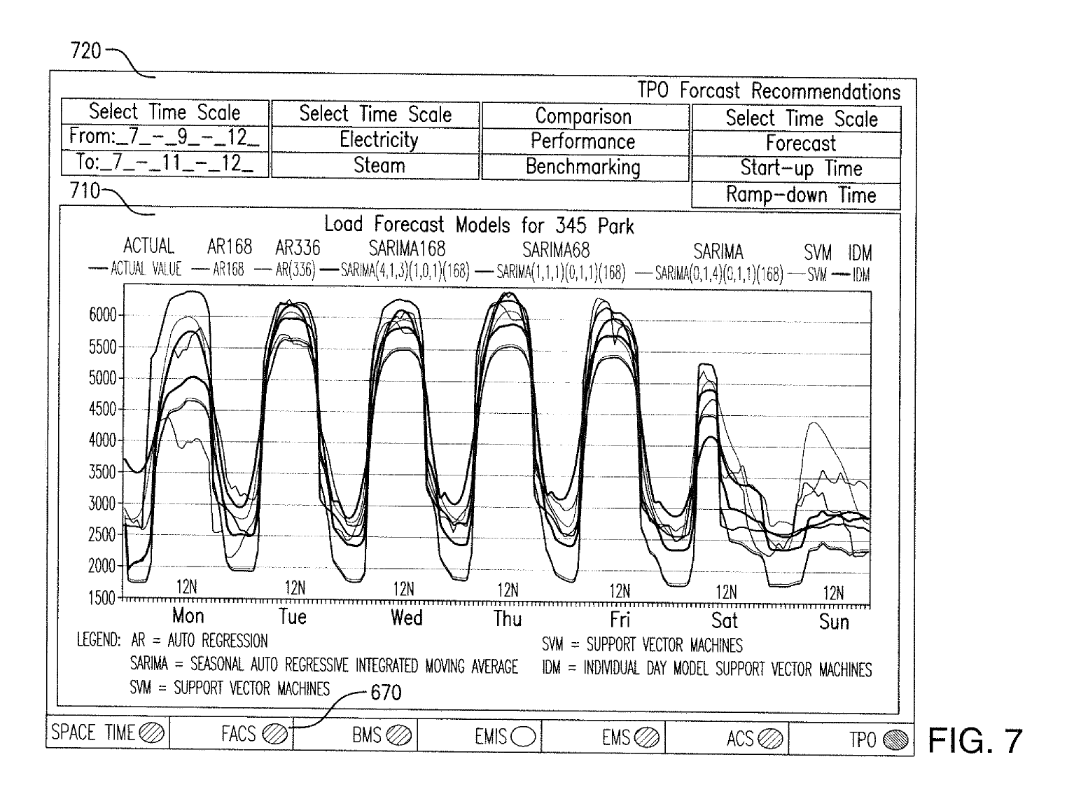

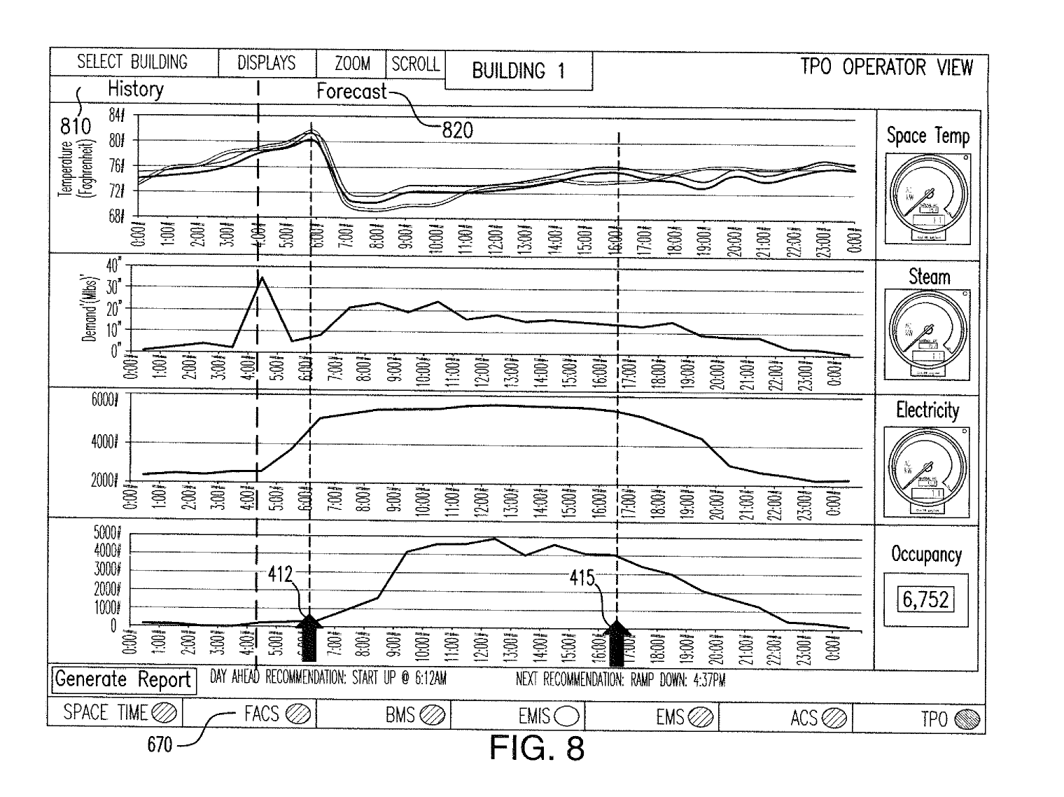

FIG. 7 depicts another exemplary user interface in accordance with the disclosed subject matter. This user interface 720, which is configured to display electric load forecasts, includes the color-coded indication bar 670. Additionally, the load forecast 710 generated, for example, from various configurations of the predictive model 315, can be displayed. In like manner, FIG. 8 depicts another exemplary user interface in accordance with the disclosed subject matter. This user interface can display forecasts and recommendations for an operator for space temperature, steam usage, and electricity usage for an upcoming day (i.e., “day-ahead recommendations”). Historical data 810 is displayed on the left side of the interface, while forecast data 820 is displayed on the right. The executable recommendations 412 and 415 are also displayed.

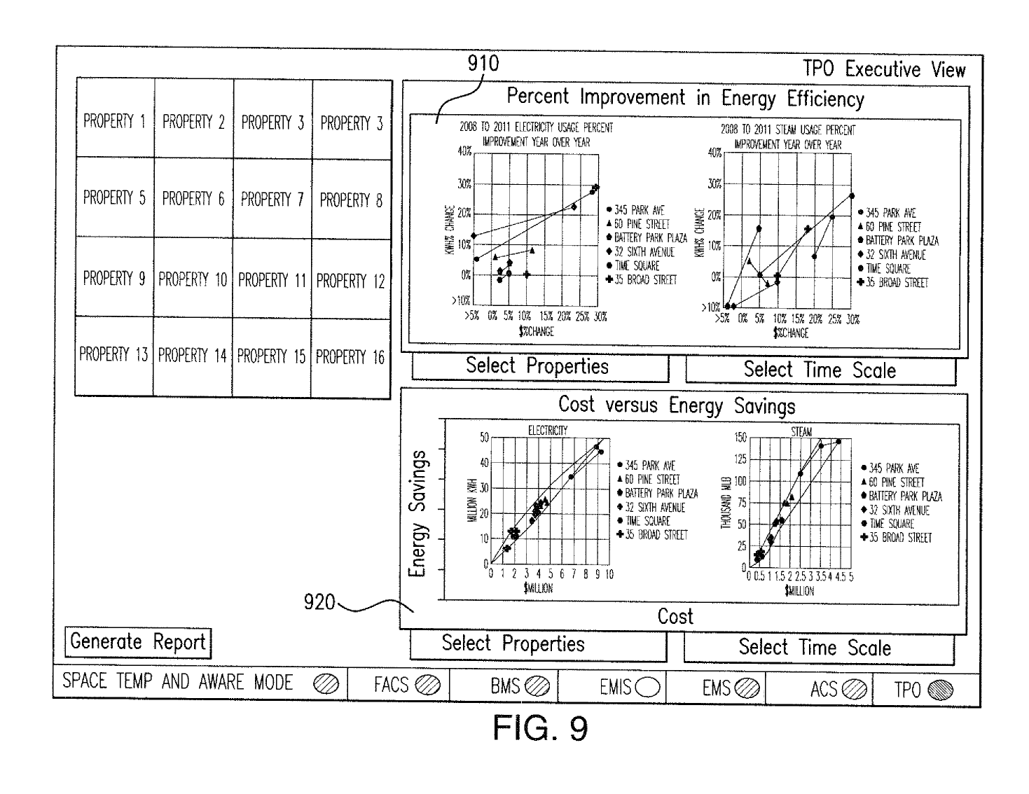

FIG. 9 depicts another exemplary user interface in accordance with the disclosed subject matter. This user interface can display a high level executive view of multiple properties. For each property, curves that illustrate a trade off between operating conditions and/or objectives, for example, efficient frontier (Pareto) curves of cost versus benefit 920, efficiency verses performance 910, or the like, can be displayed with the status of each building. For example, in connection with certain embodiments, costs and usage can be normalized into percentages of improvement over the costs and usage of a previous period. If costs increase at a faster rate than efficiency efforts to reduce consumption, overall benefit can be reduced. In this manner, an efficient frontier curve can be displayed in year-over-year percentage improvement, as illustrated in FIG. 9 and as described, for example, in U.S. patent application Ser. No. 13/589,737, which is hereby incorporated by reference in its entirety. As illustrated therein, a baseline state of energy efficiency efforts at initialization time for a set of buildings in a portfolio can be compared to an improvement above the baseline after the techniques of the disclosed subject matter have been employed.

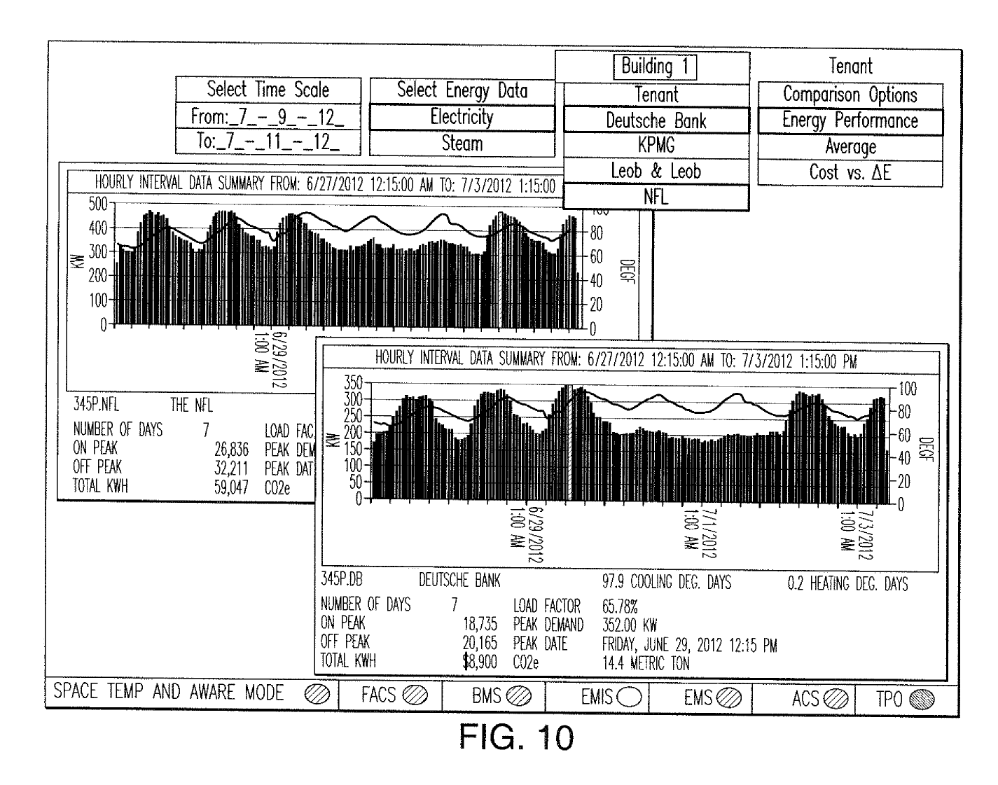

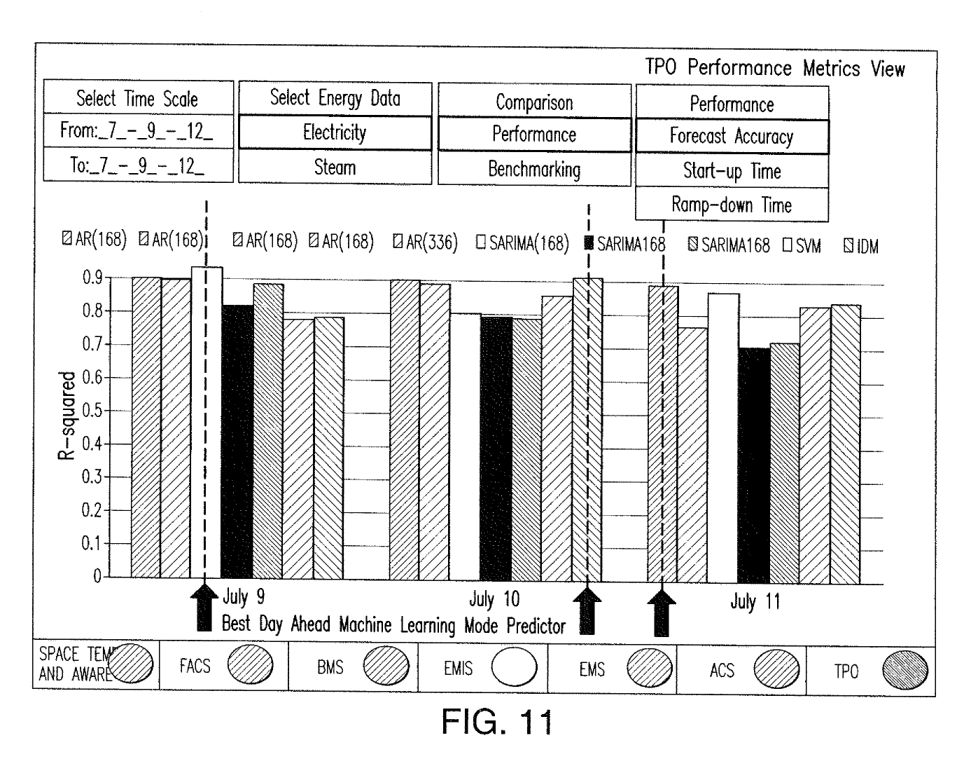

FIG. 10 depicts another exemplary user interface for displaying comparisons of energy usage of specific tenants, which can enable coordination with their secondary heating and cooling systems so as to achieve additional energy efficiencies. FIG. 11 depicts another exemplary user interface for displaying certain performance measurements 340. For example accuracy of predictions can be given by coefficient of determination (R-squared), Root-mean-square deviation (RMSE), Maximum Absolute Percentage Error (MAPE), or the like, and compared.

For purposes of illustration and not limitation, the disclosed subject matter, hereinafter referred to the “Total Property Optimizer” (TPO), will be described in connection with exemplary and non-limiting scenarios. The TPO can combine a variety of machine learning-based optimization and management tools for management of commercial office buildings. TPO can use Support Vector Machine Regression (SVR) to forecast whether real time data trends for space temperatures (tracks tenant comfort), electric loads, steam, and water usage will be in the desired performance ranges for each major building within a portfolio. A Horizon Indicator can then display historical, real-time and forecast values and provides recommendations when data points are trending towards sub-optimal performance using anomaly detection. For example, by forecasting future space temperatures by floor and quadrant (or in certain embodiments, by a finer or courser spatial division) using SVR, the Horizon Indicator can provide recommendations for next day's start up and shut down time for the heating, ventilation and air conditioning (HVAC) system and supply air fans. Thus the TPO can allow building operators, engineers, and managers to take pre-emptive actions to keep systems running smoothly. Two exemplary applications are to ensure optimal tenant comfort and efficient energy use.

Horizon Indicator can, for example, compile all available and relevant Supervisory Control and Data Acquisition (SCADA) data points in 5 to 15-minute intervals and display actual and forecast data in real time. It can display weather (forecast and actual), power quality of the electric grid, energy (steam, electric, water, and natural gas), tenant-by-tenant sub-metered electric usage, occupancy and space temperature information in each quadrant (or in certain embodiments, by a finer or courser spatial division) of a building. Other relevant data from the Building Management System (BMS), Elevator Information Management System (EMIS) and Energy Management System (EMS) can also be displayed.

Data points can be displayed independently, but can also be combined to reveal feedback between systems. Optimal value bands for data points that are intended to remain constant, such as space temperature during operating hours, can be determined by lease requirements with tenants. These bands can allow building operators to quickly see how well the building HVAC system is delivering comfortable space temperatures and identify areas of the building that require adjustment or maintenance. Using the historical database in Horizon Indicator, building operators can observe changes in data trends and use this information to identify zones of the building that are not operating optimally and investigate their root causes. Confidence interval bands based on the SVR predictions can be displayed for more dynamic data trends such as steam and electricity. To develop the confidence interval band for electric load, for example, a normal distribution on the forecast error for the SVR training set can be assumed. This normal distribution corresponding to the optimized set of parameters can be used to obtain a 95% confidence interval for forecasts in a test set. The display can also give signals for recommended start-up, ramp-down for a building's HVAC system based on SVR forecasts of space temperature.

In one embodiment, for example, Horizon Indicator can display forecast values for each data point using SVR. The data sets can contain historical data for the data point being modeled and corresponding values for covariates that correlate to the modeled data point. Exemplary covariates are provided in Table 1. The SVR model can produce regressions for each data point, forecasting, for example, the coming 24 hours, recomputed ahead every 15 minutes. These regressions can be updated on the Horizon Indicator interface in real time. Each of the data points can include as covariates many of the other data points, which indicates the feedback that exists between these systems and the desire to present them in a unified interface.

TABLE 1

| Data Point | Covariate 1 | Covariate 2 | Covariate 3 | Covariate 4 | Covariate 5 |
|---|---|---|---|---|---|
| Space | Humidex | Occupancy | Supply Air | Electric | Steam |
| Temperature | | | Temperature | Demand | Demand |
| Electricity | Humidex | Occupancy | Space | Steam | Supply Air |
| | | | Temperature | Demand | Temperature |
| Steam | Humidex | Occupancy | Space | Electric | Supply Air |
| | | | Temperature | Demand | Temperature |
| Occupancy | Space | Electric | Steam | Elevator | Turnstile |
| | Temperature | Demand | Demand | headcounts | counters |

Using forecast space temperatures, the Horizon Indicator can display recommendations of recommended HVAC start-up times. By inputting humidex derived from weather forecasts into the space temperature regression (which can be, e.g., SVR or a linear regression), the forecast can reveal the amount of time it takes each day to reach optimal space temperatures from the time the chiller machines and supply air fans are turned on. Knowing the amount of time it takes to cool or warm the building to a comfortable level, building operators can delay the start time so that the building is comfortable only during hours of the day when spaces are occupied, eliminating excess and wasted energy usage.

### Example

As previously noted, and in accordance with the disclosed subject matter, the techniques described above can enable improved energy, environment and operational efficiency and reliability of building systems. The disclosed subject matter is further described by means of an example, presented below. The use of this example is illustrative only and in no way limits the scope and meaning of the disclosed subject matter or any exemplified term. Likewise, this application is not limited to any particular embodiments described herein. Indeed, many modifications and variations of the disclosed subject matter will be apparent to those skilled in the art upon reading this specification. The disclosed subject matter is to be understood by the terms of the appended claims along with the full scope of equivalents to which the claims are entitled.

In this example, the operations dashboard for the total property optimization system (TPO) for office building management was employed for management of multiple large buildings for commercial tenants. Buildings in the property portfolio ranged from a 2 million square foot skyscraper to a 300,000 square foot office building in Manhattan. The Horizon Indicator included real time displays of space, supply, and return air temperatures/relative humidity by HVAC zone and floor for each building. Any departures from horizontal, stable “comfort zones” defined by the tenant leases were flagged as outliers. The Horizon Indicator was implemented in the largest office building—monitoring interior space temperatures from Floors 5, 18, 32, 33, and 40 of the 44 floor building. Interior space temps from floors 24, 25, 26, and 27 were recorded shortly thereafter. Afterwards, the disclosed system began receiving interior and perimeter space temperatures from Floors 2, 13, 20, 35, and 38. During a heat wave, excess temperatures were identified on Floors 2SW and 35SW and NW. The anomalies also showed up on Floor 18NW during more normal summer temperatures.

The Horizon Indicator within the TPO enabled identification of which floors were too warm based on their continuous space temperature trends compared to lease requirement comfort levels. This prompted an investigation into possible causes for the poor performance in these areas. A traverse was performed on each of the floors revealing tears in the ducts in two places. The Cubic Feet per Meter (CFM) duct outputs were measured in all troubled regions, often revealing lower than specified CFM outputs which would be the cause of high temperatures. Causes were tears in the ducts (two cases), a dirty coil, and out of balance dampers (three cases).

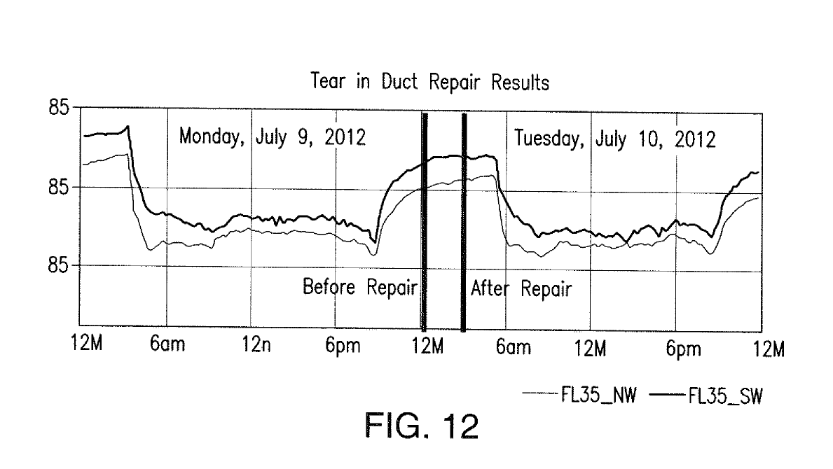

In the two regions where tears in ducts were identified, the tears were repaired overnight. After the tear was repaired the CFM output in the two areas improved, as demonstrated in table 2 and table 3 and FIG. 12.

TABLE 2
High Space Temperature Investigations

| Location | Scheduled CFMs | Measured CFMs | Problem |
|---|---|---|---|
| 2 SW | 8700 | 14196 | Dirty coil |
| 5 NW | 8700 | 12500 | Potential Open |
| | | | Damper |
| 18 SE | 3900 | 5050 | Potential Open |
| | | | Damper |
| 18 NW | 3900 | 2490 | Potential Open |
| | | | Damper |
| 35 NW | 4200 | 3600 | Tear in duct |
| 35 SW | 3900 | 3540 | Tear in duct |

TABLE 3
Tear In Duct Repair Results

| Location | Scheduled CFMs | Pre-Repair CFMs | Post-Repair CFMs |
|---|---|---|---|
| 35 NW | 4200 | 3600 | 4013 |
| 35 SW | 3900 | 3540 | 3752 |

Thus, this example demonstrates that the TPO with its Horizon Indicator can facilitate identification of operational inefficiencies caused by maintenance problems. It can lead building operators to identify causes of such inefficiencies, revealing needed repairs that can be learned by the decision algorithm system within the TPO so that improvements in the efficiency of the building resulted, all before the tenant was even aware of a problem.

The TPO system can form the decision analysis tool for a system of systems that integrates simulation models, machine learning, approximate dynamic programming, statistical diagnostics, and capital asset planning for the building, property portfolio, campus, microgrid, military base, or the like. The TPO can provide techniques for treating uncertainty from both operational and financial standpoints, simultaneously.

As described above in connection with certain embodiments, certain components, e.g., 300, 310, 315, 320, and 332, can include a computer or computers, processor, network, mobile device, cluster, or other hardware to perform various functions. Moreover, certain elements of the disclosed subject matter can be embodied in computer readable code which can be stored on computer readable media and when executed cause a processor to perform certain functions. In these embodiments, the computer plays a significant role in permitting the system and method to manage one or more buildings. For example, the presence of the computer, processor, memory, storage, and networking or hardware provides the ability to provide real time feedback from sensors and other data sources for the purpose of improving electric, steam and/or fossil fuel load forecasts and generating executable recommendations related to tenant comfort and building maintenance problems.

Additionally, as described above in connection with certain embodiments, certain components can communicate with certain other components, for example via a network, e.g., the internet or intranet. To the extent not expressly stated above, the disclosed subject matter is intended to encompass both sides of each transaction, including transmitting and receiving. One of ordinary skill in the art will readily understand that with regard to the features described above, if one component transmits, sends, or otherwise makes available to another component, the other component will receive or acquire, whether expressly stated or not.

The techniques disclosed herein can allow for cost effective, efficient and environmentally sound management of building systems. For purposes of illustration and not limitation, an exemplary embodiment is described herein. It should be apparent, however, to those skilled in the art that many more modifications besides those described herein are possible without departing from the concepts of the disclosed subject matter.

1. A method for managing one or more buildings, comprising:
collecting historical building data, real-time building data, historical exogenous data, and real-time exogenous data;
receiving the collected data at an adaptive stochastic controller; and with the adaptive stochastic controller:
generating at least one of a predicted condition with a predictive model; and
generating one or more executable recommendations based on the predicted condition and one or more performance measurements corresponding to the executable recommendations.

2. The method of claim 1, wherein the predicted condition includes at least one of the group of predicted space temperature, supply air temperature, chilled water temperature, electric load, steam consumption or fuel consumption

3. The method of claim 1, wherein collecting further comprises receiving from a building management system the historical building data, real-time building data, historical exogenous data, and real-time exogenous data, and wherein the historical building data and the real-time building data includes electric data, fuel and steam data, space temperature information, air flow rate data, chilled water temperature data, supply air temperature information, return air temperature information, lighting sensor data, elevator data, and carbon dioxide data.

4. The method of claim 1, wherein collecting further comprises querying one or more databases including the historical building data, real-time building data, historical exogenous data, and real-time exogenous data.

5. The method of claim 1, wherein collecting further comprises receiving over a network at least one of the historical exogenous data and the real-time exogenous data, and wherein the historical exogenous data and the real-time exogenous data include at least one of historical weather data, forecast weather data, and power grid data.

6. The method of claim 1, further comprising displaying on a user interface trends in one or more building conditions, the predicted conditions, and the one or more executable recommendations.

7. The method of claim 17, further comprising identifying trends in the one or more building conditions and generating a predicted condition for each building condition, and displaying the identified trends and the predicted conditions, whereby an operator is alerted when an anomaly between the predicted conditions and the building conditions arises.

8. The method of claim 7, wherein the one or more building conditions include space temperature at each measurement location of each floor in the one or more buildings.

9. The method of claim 8, wherein generating one or more executable recommendations further includes generating at least one of a recommended start-up time and ramp-down time for a HVAC system based on at least the trends in the one or more building conditions.

10. The method of claim 8, wherein generating one or more executable recommendations further includes generating at least one of a recommended start-up time and ramp-down time for a HVAC system based on at least the trends in the one or more building conditions, the predicted conditions, and the performance measurements.

11. The method of claim 1, wherein the one or more buildings includes a plurality of buildings, and further comprising displaying an efficient frontier (Pareto) curve for efficiency and performance for the plurality of buildings.

12. A system for managing one or more buildings, comprising:
a data collector to collect historical building data, real-time building data, historical exogenous data, and real-time exogenous data; and
an adaptive stochastic controller operatively coupled to the data collector and adapted to receive collected data therefrom, the adaptive stochastic controller comprising:
a predictive model configured to generate at least one predicted condition; and
a decision algorithm configured to generate one or more executable recommendations based on at least the predicted condition and one or more performance measurements corresponding to the executable recommendations.

13. The system of claim 12, wherein the predicted condition includes at least one of the group of space temperature, supply air temperature, chilled water temperature, electric load, steam consumption or fuel consumption

14. The system of claim 12, wherein the data collector is operatively coupled to a building management system, and wherein the historical building data and the real-time building data includes data from at least one of electric meters, fuel and steam sub-meters, chilled water temperature sensors, space temperature and humidity sensors, supply air temperature and humidity sensors, air flow rate sensors, return air temperature and humidity sensors, or carbon dioxide sensors.

15. The system of claim 12, wherein the data collector is operatively coupled to one or more databases including the historical building data, real-time building data, historical exogenous data, and real-time exogenous data.

16. The system of claim 12, wherein the data collector is operatively coupled to a network and configured to receive historical exogenous data and the real-time exogenous data via the network, and wherein the historical exogenous data and the real-time exogenous data include historical weather data, forecast weather data, and power grid data.

17. The system of claim 12, further comprising a user interface configured to display trends in one or more building conditions, the at least one predicted condition, and the one or more executable recommendations.

18. The system of claim 17, wherein the predictive model is further configured to identify trends in the one or more building conditions and generate a predicted condition for each building condition, and wherein the user interface is further configured to display the identified trends and the predicted conditions, whereby an operator is alerted when an anomaly between the predicted conditions and the building conditions arises.

19. The system of claim 18, wherein the one or more building conditions include space temperature at one or more measurement locations of at least one floor in the one or more buildings

20. The system of claim 19, wherein the adaptive stochastic controller is further configured to generate at least one of a recommended start-up time and ramp-down time and rate for a HVAC system based on at least the trends in the one or more building conditions.

21. The system of claim 19, wherein the adaptive stochastic controller is further configured to generate at least one of a recommended start-up time and ramp-down time rate for a HVAC system based on at least the trends in the one or more building conditions, the predicted conditions, and the performance measurements.

22. The system of claim 17, wherein the one or more buildings includes a plurality of buildings, and wherein the user interface is further configured to display an efficient frontier (Pareto) curve for efficiency and performance for the plurality of buildings.
